(19) United States
(12) Patent Application Publication
(10) Pub. No.: US 2019/0009475 A1
(43) Pub. Date: Jan. 10, 2019

(54) METHOD FOR CALCULATING A PATH IN ADDITIVE MANUFACTURING

(71) Applicant: Wematter AB, Linkoping (SE)

(72) Inventors: Robert KNIOLA, Linkoping (SE); Daniel LÄNNSTRÖM, Linkoping (SE)

(21) Appl. No.: 16/108,171

(22) Filed: Aug. 22, 2018

Related U.S. Application Data
(63) Continuation of application No. PCT/SE2018/050737, filed on Jul. 5, 2018.

(30) Foreign Application Priority Data
Jul. 5, 2017 (SE) 1750879-7

(51) Int. Cl. B29C 64/393; B33Y 50/02; B33Y 40/00; B29C 64/10; B33Y 10/00

(52) U.S. Cl. CPC B29C 64/393; B33Y 50/02; B33Y 10/00; B29C 64/10; B33Y 40/00

(57) ABSTRACT

Disclosed is a method for calculating a tool path for additive manufacturing, comprising obtaining (S110) a three-dimensional model describing an object to be formed, dividing (S120) the model into a plurality of layers, and analyzing (S120) each layer of in order to obtain at least one outline of each layer. The method further comprises analyzing (S130) each outline to obtain an inside and outside for each outline of each layer. It further comprises determining (S140) a smallest rectangle that encloses each outline, calculating (S150) an infill curve for each rectangle, using a Hilbert* algorithm. The method further comprises overlaying (S160) the outline on its corresponding rectangle, and determining (S170) which parts of the infill curve are on the inside of the outline, thus obtaining a tool path for the outline comprising at least one infill curve and the outline.

### TECHNICAL FIELD

The present solution relates to a method for calculating a path in additive manufacturing, for example a path for a tool such as a laser.

### BACKGROUND ART

Manufacturing three-dimensional objects is something that is well known within the art, and is generally referred to additive manufacturing. One form of additive manufacturing is sintering, which uses high temperature in order to shape sinterable powder into an object. The powder is typically comprised of a polymer composition or a metal alloy, and an energy beam, such as a laser, is used to cause the powder particles to fuse to one another. The process is usually based on dividing a model into layers, then manufacturing the object one layer at a time.

When dividing an object to be manufactured in to layers and subsequently using an energy beam to create each layer, a path for the tool to be used, typically an energy beam, needs to be calculated for each layer. How such a tool path is calculated is a very complex matter, since there are a multitude of different variables to take into account. For example, it is desirable to have as few starts and stops as possible, it is desirable to have as evenly distributed energy density as possible over the area to be manufactured and it is desirable to have a tool path which optimizes the travel time.

With current technologies for calculating and providing a tool path in additive manufacturing, it is very difficult to achieve these properties. Thus, it would be advantageous to find a better way of providing a tool path for additive manufacturing.

### SUMMARY

It is an object of the solution to address at least some of the problems and issues outlined above. It is possible to achieve these objects and others by using devices and systems as defined in the attached independent claims.

According to one aspect, there is provided a method for calculating a tool path for additive manufacturing. The method comprises the step of obtaining a three-dimensional model describing an object to be formed, the model being represented in a coordinate system comprising and x-axis, y-axis and a z-axis, and dividing the model into a plurality of layers from one end of the mode along one axis among the x-axis, y-axis and z-axis to the opposite end of the model on the same axis. The method further comprises analyzing each layer of the plurality of layers, in order to obtain at least one outline of each layer and then analyzing each outline of the at least one outline for each layer in order to obtain an inside and outside for each outline of each layer. The method further comprises, for each outline not enclosed by another outline, determining a smallest rectangle that encloses the outline and calculating an infill curve for each rectangle, using a Hilbert* algorithm. The method further comprises, for each outline, overlaying the outline on its corresponding rectangle and determining which parts of the infill curve are on the inside of the outline, thus obtaining a tool path for the outline comprising at least one infill curve and the outline.

According to an optional embodiment, the method further comprises the step of compensating for a tool size for each outline, thus obtaining a tool optimized outline for each outline.

According to an optional embodiment, the step of determining which parts of the tool path are on the inside of the outline comprises using Boolean operators.

According to an optional embodiment, the method further comprises the step of removing lines of the infill curves that are shorter than a predetermined length.

The aspects and embodiments described herein are freely combinable with each other.

### SHORT DESCRIPTION OF THE DRAWINGS

The solution will now be briefly described, by way of example, with reference to the accompanying drawings, in which:

FIG. 1 shows the steps of a method according to the present disclosure.

FIG. 2A shows a layer of an object to be manufactured comprising one outline.

FIG. 2B shows a layer of an object to be manufactured comprising three outlines.

FIGS. 3A-3C show different versions of what is shown in FIG. 2B depending on what is considered an outside and what is considered an inside.

FIG. 4A shows a layer of an object to be manufactured comprising two outlines that are connected to each other.

FIG. 4B shows a layer of an object to be manufactured comprising two outlines that are not connected to each other.

FIG. 5 shows the process of adapting a tool path calculated by use of a Hilbert* algorithm for a circular shape.

### DESCRIPTION OF EMBODIMENTS

In the following, a detailed description of the different embodiments of the solution is disclosed with reference to the accompanying drawings. All examples herein should be seen as part of the general description and are therefore possible to combine in any way in general terms. Individual features of the various embodiments and methods may be combined or exchanged unless such combination or exchange is clearly contradictory to the overall function of the implementation.

Shortly described, the present disclosure relates to a method for calculating a tool path in additive manufacturing, such as a path for a laser which is used for fusing the particles together in a sintering system. The method may be a method for additive manufacturing wherein a tool path is calculated, in some embodiments comprising the step of manufacturing an object based on the calculated tool path. The method may be an additive manufacturing process comprising a method for calculating a tool path, in some embodiments comprising manufacturing an object based on the calculated tool path. The method builds upon the realization that fractal algorithms may be used for calculating a tool path in a more optimal way than has been possible previously. However, the presently available fractal algorithms for calculating paths all have certain limitations, such as only being applicable to square shapes and not to arbitrary shapes. The present method presents a way to overcome the limitations of the available fractal algorithms, specifically the so-called Hilbert* algorithm, by first calculating an infill curve, which is the curve to be used as a tool path, for a rectangle, which the Hilbert* algorithm is adapted for doing. Then the shape that is to be manufactured is overlaid on the rectangle with the calculated tool path, and the infill curve which remains inside of the shape, together with the outlines of the shape, is used as a tool path for manufacturing the shape. The invention will now be described more in detail with reference to the accompanying drawings.

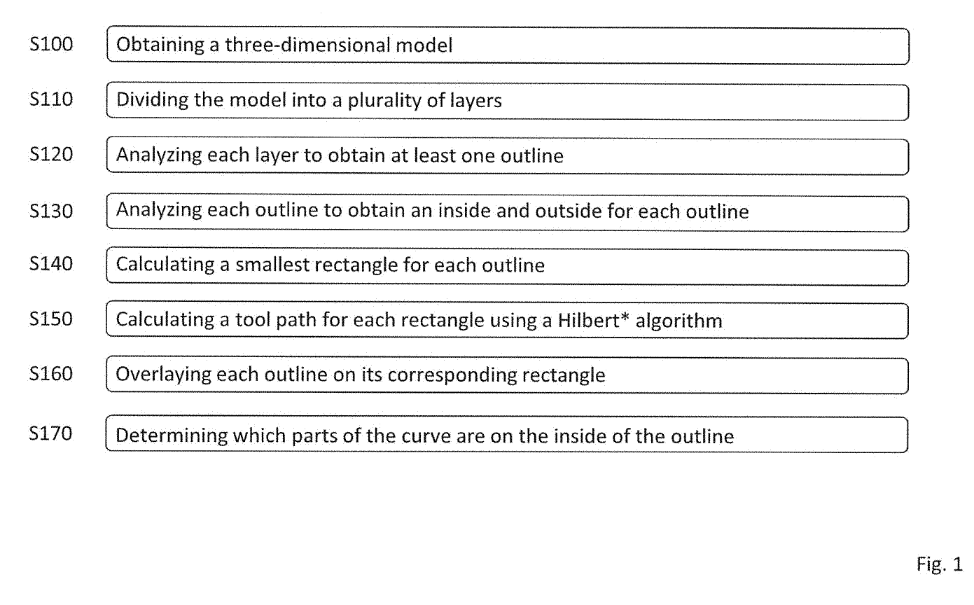

FIG. 1 shows the steps of a method according to the present disclosure. In a first step S100, a three-dimensional model of an object to be manufactured is obtained. The model is typically obtained in the form of a file which is possible to upload and download via a computer means. The three-dimensional model is represented in a three-dimensional coordinate system comprising three axes, typically an x-axis, a y-axis and a z-axis.

In a second step S110, the model is divided into a plurality of layers, from one end of an axis to the opposite end of the same axis in the coordinate system, i.e. the three-dimensional model is split into a plurality of two-dimensional slices. Generally it doesn't matter along which axis the model is divided along, but in some embodiments it may be preferred to start at either the axis along which the model has the longest extension or the axis along which the model has the shortest extension.

In a third step S120, each layer of the plurality of layers is analyzed in order to obtain at least one outline for each layer. An outline, as used herein, refers to a continuous line that encloses an area. Depending on the shape of the object to be formed, and subsequently on each layer of that object, a layer may have one or more outlines. A simple solid object, i.e. an object with no holes or hollow spaces in it, typically comprises only one outline per layer, whereas more complex objects may comprise multiple outlines per layer. The reason for using the term outline will be explained further in relation to the next step, in which an inside and an outside is determined for each outline.

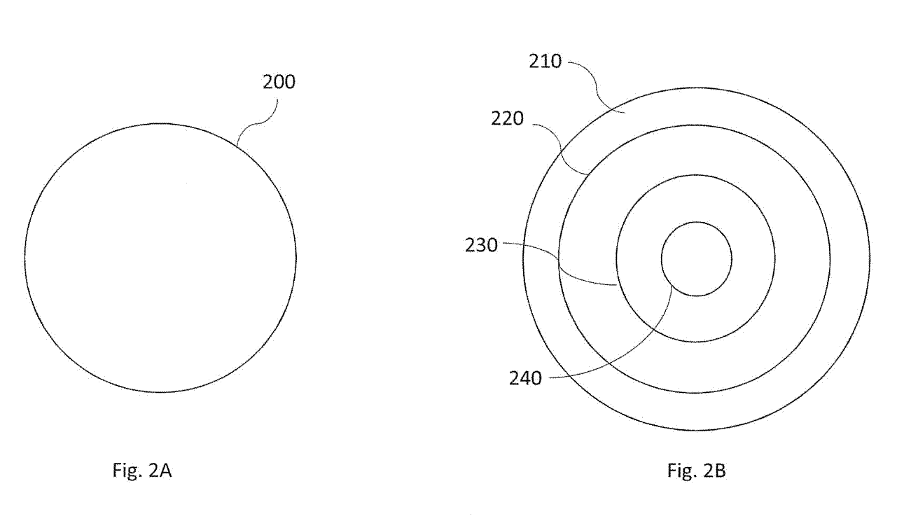

In a fourth step S130, each outline is analyzed in order to determine what is considered an “inside” for the outline and what is considered an “outside”. The reason for doing this is to determine which side of the outline should be filled with solid material, which process will now be explained in reference to FIGS. 2A and 2B.

FIG. 2A shows a layer comprising only one outline 200. In the case where there is only one outline, everything enclosed by the outline will be considered an inside and everything not enclosed by the outline will be considered an outside. The inside will be filled with material and processed during an additive manufacturing process, which produces the shape inside of the outline. The outside will not be filled with any material, i.e. it will be empty space. Consequently, in the example shown in FIG. 2A, the outline will result in a circle filled with material. In other words, the term inside is used to refer to the parts of a model of an object, more specifically of a layer or an outline of a layer, that should be filled with material, and the term outside is used to refer to the parts that should not be filled with material, i.e. that should be empty space.

However, more complex shapes may comprise multiple outlines, and in these cases it becomes important to determine which parts are insides and which parts are outsides. FIG. 2B shows a layer comprising four outlines 210, 220, 230, 240. Depending on what is considered an outside and what is considered an inside, the manufactured product resulting from the layer shown in FIG. 2B can differ.

If what is enclosed by outline 240 is considered an inside, then the space between what is enclosed by outline 230 and outline 240 would be considered an outside. Further, this would result in that the space between what is enclosed by outline 220 and outline 230 is considered an inside. Then, the space enclosed by 210 and 220 would be considered an outside, and further everything outside of outline 210 would also be considered an outside, although the line represented by 210 would be filled with material, thus resulting in a very thin layer of material. This may also be seen as the outline 210 in reality being represented by two outlines with a very small distance in between them, wherein the area between these outlines is filled whereas the area outside of it is not filled.

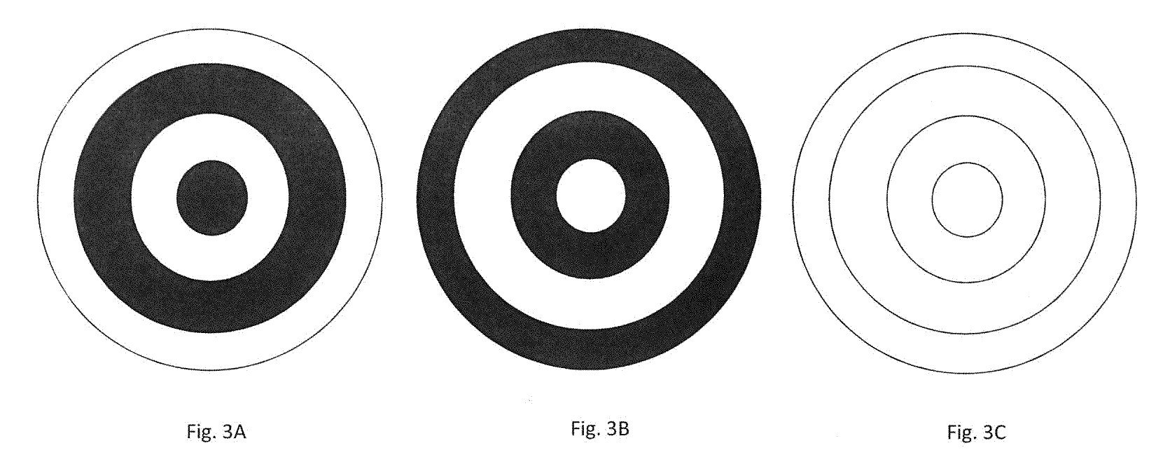

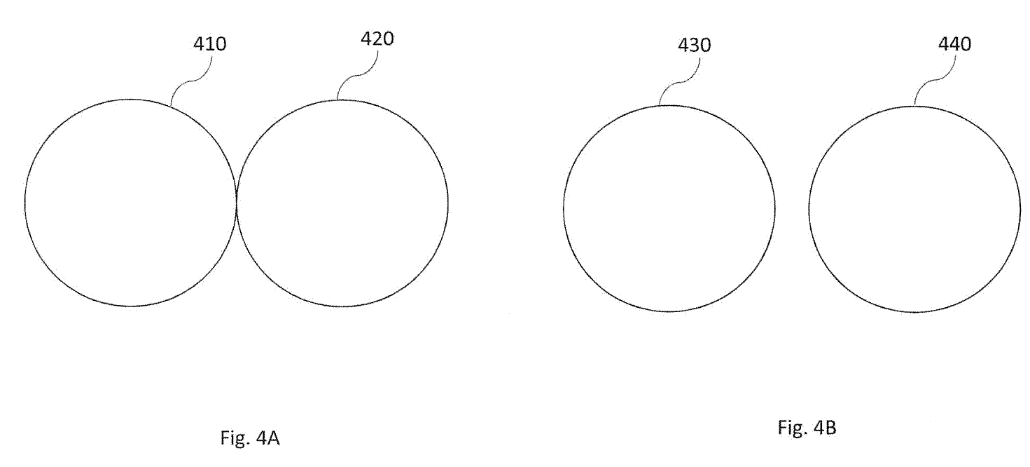

The resulting product from the layer shown in FIG. 2B when the relationships between insides and outsides are as detailed above is shown in FIG. 3A. If the relationships are the opposite, the resulting product would look like what is shown in FIG. 3B.

It may also be such that all outlines 210, 220, 230, 240 are considered as two outlines each, wherein each of these two outlines are considered to enclose a very small area between them. This would result in a product such as the one shown in FIG. 3B, with four thin layers with empty space in between them. As will be understood, there may be further variations of the examples explained in relation to FIG. 2B, with combinations of the different examples mentioned.

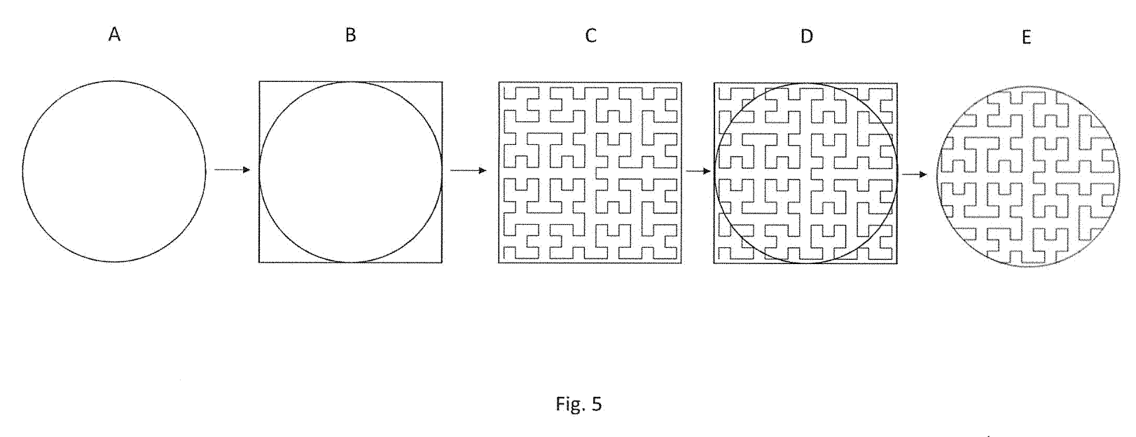

The following three steps of the method, S140-S170 are related to how to make a curve calculated by a Hilbert* algorithm applicable to arbitrary shapes. As mentioned, the Hilbert* algorithm is adapted for calculating a curve for rectangles, while the present method is applicable to any kind of shape. As mentioned, a key insight of the present disclosure is that the Hilbert* algorithm is suitable for calculating a curve usable as a tool path which results in a product with desirable characteristics, while also making the manufacturing process optimized in regard to energy density, time and energy consumption during manufacturing. However, the Hilbert* algorithm is only useable for rectangular shapes, an obstacle which the present disclosure overcomes, and the method of doing this is another key insight of the present disclosure. Steps S140-S170 are shown visually in FIG. 5, which will also be referenced in relation to the explanation of these steps.

In a fifth step S140, the smallest rectangle which encloses the outline is determined for each outline, or at least for each outline not enclosed by another outline. An example of an outline enclosing another outline is e.g. the outer outline 210 in FIG. 2B. As can be seen, also outlines 220 and 230 enclose at least one more outline. However, the only outline not enclosing another outline in FIG. 2B is outline 210.

In the case that two outlines are connected, but neither is enclosing any part of the other one, a smallest possible rectangle will typically be calculated that encloses both outlines, rather than for each outline. However, as will be understood, it is possible to calculate one for each outline as well, but it is less efficient. In other words, in case of two outlines being connected to each other, they will be treated as one outline not being enclosed by another outline for the purpose of step S140. Calculating a Hilbert* curve typically requires a certain amount of power per area unit for which it is to be calculated, so the aim is to minimize the amount of Hilbert* curve that needs to be calculated for the infill curve, while still calculating as much as is needed for providing a suitable tool path.

In some embodiments, step S140 comprises determining the smallest rectangle enclosing each part of an outline that is considered an inside, i.e. the part that is to be filled with material during a manufacturing process. As will be understood, in case the outline is comprised by a rectangle, the outline and the smallest rectangle enclosing it may be the same. Phase A in FIG. 5 shows an outline to be enclosed, and phase B shows the result of step S140, i.e. an outline enclosed by the smallest possible rectangle for enclosing it.

In a sixth step S150, an infill curve to be used as basis for a tool path is calculated for each rectangle obtained in step S140, by using a Hilbert* algorithm. This infill curve represents a path that would be suitable for a tool to follow when manufacturing each rectangle in an additive manufacturing process. Phase C in FIG. 5 shows a rectangle with an infill curve calculated by using the Hilbert* algorithm. Typically, the infill curves for a rectangle calculated by use of a Hilbert* algorithm comprises one continuous line, and thus requires no intermediate starting and stopping when following the line with an additive manufacturing tool.

In a seventh step S160, each outline is overlaid on its corresponding rectangle, as shown in phase D in FIG. 5. As will be understood, this does not need to be a visual operation, the intersection between the Hilbert* curve and the outline may be obtained by performing calculations, which is typically the case. In other words, the step of overlaying each outline on its corresponding rectangle may comprise calculating a relationship between the outline, rectangle and the curve inside of the rectangle, in order to determine which parts of the infill curve are inside of the outline.

Although step S140 is typically performed only for each outline not enclosed by another outline, step S160 is performed for each outline. For example, for the layer shown in FIG. 2B, the smallest rectangle would be calculated for outline 210, but each outline 210, 220, 230, 240 would then be overlaid on the rectangle in order to determine which parts of the infill curve are inside of each outline, or inside of each inside of each outline.

Then, in a step S170, it is determined which parts of the infill curve of each rectangle is inside of its respective outline. This may be done by calculating the intersections between the curve, the rectangle and the outline. The outline itself together with the infill curve inside of the outline, forms the tool path that is to be used for manufacturing that outline. In some embodiments, step S170 is performed only on the parts of each outline that have been determined to be an inside, since those are the only parts that are to be manufactured. For example, in FIGS. 3A and 3B, the parts of the infill curve that would be covered by the black parts are the parts that are to be determined as inside of their respective outline, and thus the parts for which it will be determined which parts of the infill curve is inside of.

As will be understood, since the outline intersects with the infill curve inside of each rectangle, the resulting infill curve inside of each outline will typically comprise a number of lines rather than only one continuous line. The exception to this case is when the outline is a rectangle, and in this case the resulting curve inside of the outline will comprise one continuous line. This also entails that the tool path to be used for manufacturing the object typically comprises multiple starting points and consequently also multiple stopping points.

For each outline, the combination of the outline and the infill curves inside of the outline, constitutes the tool path. For each layer, the combination of all outlines of that layer and the infill curves inside of those outlines, calculated as described above, constitutes the tool path. Thus, after step S170 has been performed for each outline of each layer of the three-dimensional object, the required data for manufacturing the object according to the present method has been obtained. The manufacturing process then entails, for each outline of each layer, following the tool path for each outline. In some embodiments, the present method may also comprise the steps of performing the additive manufacturing by use of a tool, such as a laser, and following the calculated Hilbert* paths for each outline. In other words, the method may further comprise a step of manufacturing the object to be formed based on the obtained tool path.

In some embodiments, the method may further be adapted to take the diameter of a tool, such as a laser, which is to be used in the manufacturing process into account. This may be done in a step S135 of compensating for a tool path for each outline, thus obtaining a tool optimized outline for each outline. In embodiments comprising the step S135 the tool optimized outline is used instead of the regular outline in the subsequent steps S140-S170. By performing step S135, it is easier to achieve a distance between the outline and the parts of the calculated Hilbert* curve that are determined to be inside of the outline, that results in optimal characteristics of the manufactured object. The distance between the outline and the infill curve is typically determined based on the size of the tool to be used for manufacturing.

In some embodiments, step S170 comprises uses Boolean operators for calculating the resulting tool path, i.e. the outline enclosing an infill curve and the outline itself. The operator for determining what is shown in phase E may be “what is enclosed by the outline” AND “what comprises an infill curve”.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more”. Moreover, it is not necessary for an apparatus or method to address each and every problem sought to be solved by the presently described concept, for it to be encompassed hereby.

1. A method for calculating a tool path for additive manufacturing, comprising the steps of:
obtaining a three-dimensional model describing an object to be formed, the model being represented in a coordinate system comprising and x-axis, y-axis and a z-axis;
dividing the model into a plurality of layers from one end of the mode along one axis among the x-axis, y-axis and z-axis to the opposite end of the model on the same axis;
analyzing each layer of the plurality of layers, in order to obtain at least one outline for each layer;
analyzing each outline of the at least one outline of each layer in order to obtain an inside and outside for each outline of each layer;
wherein, for each outline not enclosed by another outline:
determining a smallest rectangle that encloses the outline;
calculating an infill curve for each said rectangle, using a Hilbert* algorithm; and
for each outline:
overlaying the outline on its corresponding rectangle, and
determining which parts of the infill curve are inside of the outline, thus obtaining a tool path for the outline comprising at least one infill curve and the outline.

2. The method according to claim 1, further comprising the step of compensating for a tool size for each outline, thus obtaining a tool optimized outline for each outline.

3. The method according to claim 1, wherein the step of determining which parts of the tool path are on the inside of the outline comprises using Boolean operators.

4. The method according to claim 1, further comprising the step of removing lines of the infill curves that are shorter than a predetermined length.

5. The method according to claim 1, further comprising manufacturing the object based on the obtained tool path.
